(19) United States
(12) Patent Application Publication
(10) Pub. No.: US 2014/0158225 A1
(43) Pub. Date: Jun. 12, 2014

(54) Condensate Liquid Level Control System

(71) Applicant: Ross McBride, Hillsboro, OR (US)

(72) Inventor: Ross McBride, Hillsboro, OR (US)

(21) Appl. No.: 13/712,595

(22) Filed: Dec. 12, 2012

(51) Int. Cl. G05D 9/12

(52) U.S. Cl. CPC G05D 9/12
USPC 137/392

(57) ABSTRACT

A condensate pump system for collecting condensate liquid within a reservoir 50 and pumping out the liquid to predetermined levels comprising a reservoir 50, a, a pump 10, a transistor 20, a relay 30, and a low voltage direct current power source wherein a sensing voltage is introduced (a power probe 1 or reservoir 50) into the condensate liquid such that the liquid level is detected via the two sensing probe conductors (hold probe 2 and on probe 3) within the reservoir 50 transferring the sensing voltage to the base leg 20B of the transistor 20 which in turn powers a relay 30 that powers the pump 10 when the energized liquid is contacting the upper conductor 3 at the desired maximum level 4 and disconnects the pump 10 from power when the energized liquid no longer contacts the lower conductor 2 at the desired minimal level 5.

### FIELD OF ART

The inventions relates to system that controls the minimum and maximum liquid levels within a condensate reservoir using only low voltage direct current to energize the liquid, sense the level of the liquid, and power a pump to maintain desired range of liquid level within the reservoir

### BACKGROUND OF THE INVENTION

Many different methods and apparatus have been deployed for controlling or maintaining predetermined liquid levels within condensate reservoirs using a combination of controller circuits, float switches, pumps and relays. The float switches are prone to failure, especially in the high humidity corrosive environments that condensate pumps often are installed.

One prior art solution taught in U.S. Pat. No. 3,657,556 by Foster addressing marine bilge pump control eliminates the float switches by using two circuits having a plurality of electronic components including several conductors located within the reservoir. The liquid only becomes energized at the maximum level, shortly after the pump starts removing liquid and the liquid is no longer energizes, therefore the Foster device necessarily relies on the sensing of the impedance state. To sense the impedance several discrete electronic components including reverse-blocking triode thyristor, plurality of resistors, and at least two transistors are needed increasing costs and decreasing reliability. Also, using impedance as a sensing method for condensate pump liquid is problematic, as the pH is not constant in condensate liquid, and corrosion or scaling on the electrodes or anodes is common, thus making impedance sensing untenable.

Other problems with current condensate liquid control systems is that they are completely operated on a/c wall power like 120 v or 240 v a/c which introduce hazards relating to ignition of flammable gasses requiring a credentialed electrician to install in most States, rather than the HVAC technician. Condensate liquid control systems that present an ignition hazard may not be installed within 18 inches of the floor in garages where flammable vapors might be present per most building codes in the United States. This is a significant problem in most HVAC installs as the condensate drain line is usually located within 18 inches of the floor thereby requiring an auxiliary pump to pump the condensate liquid up into the reservoir.

These challenges are each overcome in the singular and in the aggregate by the presented invention as described and shown herein.

### SUMMARY OF INVENTION

The invention relates to an improved condensate reservoir 50 liquid control system that is not effected by pH changes of the condensate liquid and does not utilize float switches that are prone to failure. The inventions advantages a low voltage direct current power source (herein after low voltage d/c) for energizing the liquid condensate within a reservoir 50, and senses the energized liquid condensate with a single circuit having two probe conductors, an on-probe 3 having a conductor at the desired maximum level 4 and a hold-probe 2 having a conductor at the desired minimum level 5, constructed and arranged in the preferred embodiment such that the single circuit having only one bipolar transistor 20 powers via relay 30 the pump 10 with low voltage when the energized liquid contacts the on-probe 3 conductor, the pump 10 remaining powered on until the energized liquid falls below the hold-probe 2 conductor, at which time the systems resets until the liquid level again reaches the on-probe 3. By energizing the liquid condensate and keeping it energized, the electronic componentry is minimized, decreasing manufacture costs while increasing reliability.

A first object of this invention to provide a condensate reservoir 50 liquid level control system which is adapted to maintain a liquid level in a condensate reservoir 50 within desired limits without using float switches using a single bipolar transistor 20 to increase reliability.

A second object of this invention to provide a condensate reservoir 50 liquid level control system which is adapted to maintain a liquid level in a condensate using only low voltage power allowing for HVAC technician install within 18 inches of the floor, avoiding the problems previously discussed requiring a credentialed electrician and the install of an ancillary pump.

A third object of this invention to provide a condensate reservoir 50 liquid level control system which is adapted to maintain a liquid level in a condensate while having no hazard of ignition of flammable gas or liquids, thereby allowing for convenient floor level install.

A fourth object of this invention is to provide a liquid control system achieving the above that is simple to manufacture, easy to maintain, and reliable in operation. Other objects of the invention will become obvious to one skilled in the art upon review of this specification.

There is a need for a condensate reservoir liquid control system that overcomes the shortcomings of the prior art comprising the features of construction, combinations of elements, and arrangement of parts which will be exemplified in the constructions hereinafter set forth, and the scope of the invention will be provided for in the claims.

REFERENCE TABLE

| | |
|---|---|
| 1 | Power Probe |
| 2 | Hold Probe |
| 3 | On Probe |
| 4 | Maximum Level |
| 5 | Minimum Level |
| 10 | Pump |
| 20 | Bipolar Transistor |
| 20B | Base Leg |
| 20C | Collector Leg |
| 20E | Emitter Leg |
| 30 | Relay |
| 31 | Hold switch |
| 32 | Pump switch |
| 50 | Reservoir |

### BRIEF DESCRIPTION OF THE DRAWING

FIG. 1 is a diagrammatical representation with schematic of the preferred embodiment having three probes

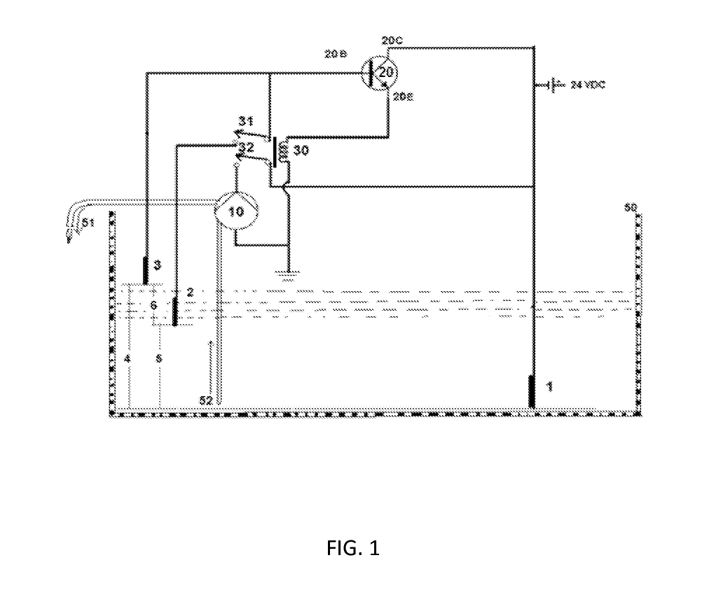

FIG. 2 is a diagrammatical schematic of an alternative embodiment having two probes and a conducting reservoir

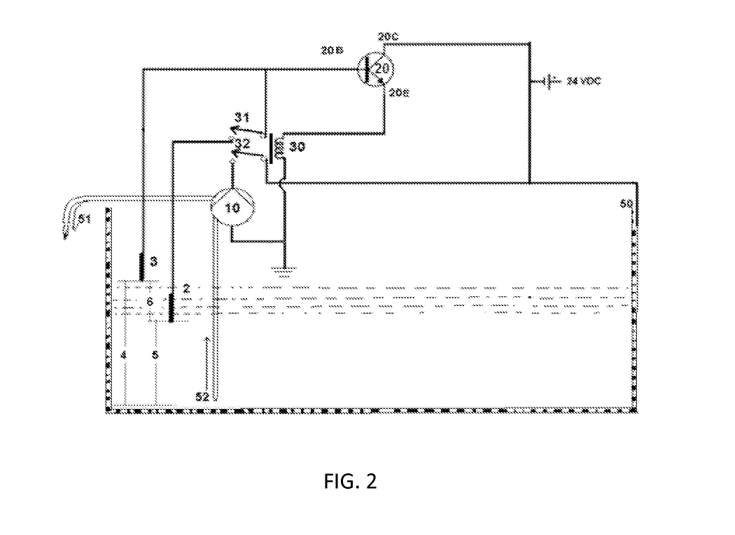

### DETAILED DESCRIPTION OF THE DRAWING

For a better understanding of the nature and objects of the invention, reference should be had to the following detailed description taken in connection with the accompanying drawings, in which: The invention does not use alternating current a/c or high voltage to sense and control the system, does not require a digital processor, does not require float switches, and may be installed in most states by a HVAC (credential) professional without the need of a licensed electrician. Further, the system as presented produces no glow, spark, or flame sufficient to ignite flammable vapors, thereby reducing fire hazards and allowing installation at ground level in States and Municipalities that otherwise would require the system to be kept at a minimum 18 inches off the ground. Applicants system does not present any ignition hazard thereby allowing install in locations not feasible otherwise.

To improve understanding of the preferred embodiment, when the term ‘low d/c voltage’ is used herein it means up to 36 volts direct current (36 d/c), and for the preferred embodiment 24 d/c is the selected low voltage for energizing the liquid, actuating the relay 30, and for powering the pump 10, which is done by a single power source. However, other embodiments still using low d/c voltage to energize and sense the liquid level may include components (i.e. relay 30 and pump 10) that are powered by common wall power such as 120 a/c or 240 a/c.

The reservoir 50 for the preferred embodiment is constructed from non-conductive materials like plastics and then the liquid is energized via a power-probe 1. In other embodiments the reservoir 50 could be made from conductive materials and directly connected to the low voltage thereby directly energizing the liquid without the power-probe 1 so long as the conductive reservoir is isolated or insulated.

In the preferred embodiment, the sensing of liquid level is performed by introducing a relatively low d/c voltage near the bottom of a non-conductive reservoir 50 using a power-probe 1. The liquid within the non-conductive reservoir 50 is maintained in an energized state thereby allowing for reliable sensing of the liquid using inexpensive probes (hold probe 2 and on probe 3) that will conduct the sensing voltage even when the probe's conductors become partially fouled from scaling or corrosion, this increased reliability is due to the relatively large delta in sensing voltage as introduced by the power-probe 1 or alternatively in other embodiments, from a conductive reservoir 50 directly. By maintaining the liquid at an energized state, problems associated with pH variations of the liquid causing impedance changes are avoided, and the energized liquid allows for a simpler more robust design having minimal electronic components.

The ‘on-probe’ 3 is located within the reservoir 50 having a conductor located at the maximum level 4 of desired liquid within the non-conductive reservoir 50. A hold-probe 2 is located within the non-conductive reservoir 50 having a conductor at the minimum level 5 of desired liquid within the reservoir 50. In practice, when energized liquid reaches the maximum level 4 in the non-conductive reservoir 50, the on-probe 3 conductor contacts the energized liquid such that sensing current is received at the base leg 20B of the bipolar transistor 20. The bipolar transistor 20 is connected at the collector leg 20C to the low voltage source all the time with the emitter leg 20E connected to a relay 30, whereby upon receiving the sensing voltage at the base leg 20B, the bipolar transistor's 20 current gate is opened and the emitter leg 20E actuates a relay 30 that closes two normally open switches, a hold-switch 31 and a pump-switch 32.

The pump-switch 32 when closed connects a pump 10 in fluid communication with the energized liquid to low voltage power thereby lowering the energized liquid level by pumping the liquid from the non-conductive reservoir 50.

The hold-switch 31 when closed connects the hold-probe 2 conductor to the base leg 20B of the bipolar transistor 20 such that as the energized liquid level is decreased within the nonconductive reservoir 50 by the pumping, the bipolar transistor base leg 20B continues to receive sensing voltage from the remaining energized liquid until the hold-probe 2 conductor is clear of the energized liquid, at which time the base leg 20B no longer receives sensing power, the bipolar transistor 20 closes the gate shutting off current to the emitter leg 20E which in turn causes the relay 30 to deactivate, the pump-switch 32 goes to open stopping the pump 10, the hold-switch 31 goes opens disconnecting the hold-probe 2 from the base leg 20B, and the system is reset until the liquid level again reaches the on-probe 3 conductor. In other embodiments the same in sensing function occurs without the power probe 1 which is replaced with a conductive reservoir 50 wherein the liquid is energized by the reservoir 50 rather than a power-probe 1.

Physical locations of the pump 10 include inside the reservoir 50 or outside the reservoir 50 with an input tube 52 and output tube 51 facilitating the removal of the liquid. To prevent hazards of ignition of flammable materials or gasses if using a higher voltage a/c pump 10 or a/c/relay 30 the a/c components are submersed in an insulated case within the energized liquid thereby eliminating the hazard.

I claim:

1. A condensate pump system for collecting condensate liquid within a reservoir 50 and pumping out the liquid to predetermined levels comprising:
a non-conductive reservoir 50 for collecting the condensate liquid;
a bipolar transistor 20 having a transistor base leg 20B, transistor emitter leg 20E, and a transistor collector leg 20C, said collector leg 20C connected to a low voltage power source;
a pump 10 connected to said low voltage power source through a normally open pump-switch 32;
an on-probe 3 connected to said transistor base leg 20B, said on-probe 3 having a conductor located within the non-conductive reservoir 50 at the desired maximum level 4;
a hold-probe 2 connected to said transistor base leg 20B through a normally open hold-switch 31, said hold-probe 2 having a conductor located within the non-conductive reservoir 50 at the desired minimum level 5;
a power-probe 1 connected to said low voltage direct current power source, said power-probe 1 having a conductor located within the non-conductive reservoir 50 below the desired minimal fluid level thereby energizing the condensate liquid with a sensing voltage;
a relay 30 activated by said transistor emitter leg 20E closes said hold-switch 31 and said pump-switch 32 when the transistor base leg 20B receives sensing voltage from energized liquid contacting said on-probe 3 conductor, whereby said relay 30 remains activated while the transistor base leg 20B receives sensing voltage from liquid contacting said hold-probe 2 conductor, said relay 30 deactivates upon the liquid level falling below the hold-probe 2 conductor, and thus the pump 10 is connected to power upon the liquid reaching the desired maximum level 4 and disconnects from power upon the liquid reaching the desired minimum level 5.

2. A condensate pump system for collecting condensate liquid within a reservoir 50 and pumping out the liquid to predetermined levels comprising:
a conductive reservoir 50 connected to a low voltage direct current source that collects and energizes condensate liquid with a sensing voltage;
a transistor 20 having a transistor base leg 20B, transistor emitter leg 20E, and a transistor collector leg 20C, said collector leg 20C connected to said conductive reservoir 50;
a pump 10 connected to said conductive reservoir 50 through a normally open pump-switch 32;
an on-probe 3 connected to said transistor base leg 20B, said on-probe 3 having a conductor located within the conductive reservoir 50 at the desired maximum level 4;
a hold-probe 2 connected to said transistor base leg 20B through a normally open hold-switch 31, said hold-probe 2 having a conductor located within the conductive reservoir 50 at the desired minimum level 5;
a relay 30 activated by said transistor emitter leg 20E closes said hold-switch 31 and said pump-switch 32 when the transistor base leg 20B receives sensing voltage from energized liquid contacting said on-probe 3 conductor, whereby said relay 30 remains activated while the transistor base leg 20B receives sensing voltage from liquid contacting said hold-probe 2 conductor, said relay 30 deactivates upon the liquid level falling below the hold-probe 2 conductor, and thus the pump 10 is connected to power upon the liquid reaching the desired maximum level 4 and disconnects from power upon the liquid reaching the desired minimum level 5.

3. A condensate pump system of claim 1 or 2, wherein the condensate pump system further includes a visual or auditory indicator of system status.

4. A condensate pump system of claim 1, wherein the pump 10 is powered by connection to an a/c high power source through a normally open pump-switch 32.

5. A condensate pump system of claim 1, wherein the pump 10 is powered by connection to an a/c high power source through a normally open pump-switch 32.
